(19) United States
(12) Patent Application Publication
(10) Pub. No.: US 2017/0341915 A1
(43) Pub. Date: Nov. 30, 2017

(54) WORK VEHICLE AND WORK VEHICLE CONTROL METHOD

(71) Applicant: Komatsu Ltd., Tokyo (JP)

(72) Inventors: Shinji Kaneko, Oyama-shi (JP); Jun Hashimoto, Chigasaki-shi (JP); Yuji Kikuyama, Hiratsuka-shi (JP)

(21) Appl. No.: 15/509,965

(22) PCT Filed: May 31, 2016
(86) PCT No.: PCT/JP2016/066074

§ 371 Date: Mar. 9, 2017

(51) Int. Cl. B66F 9/075; B62D 15/02; B62D 5/09

(52) U.S. Cl. CPC B66F 9/07568; B62D 5/09; B62D 15/0215

(57) ABSTRACT

A method of controlling a work vehicle including a steering cylinder operating a steering wheel by hydraulic oil supplied thereto, a steering member receiving an input for operating the steering wheel, and a steering valve unit which is connected to the steering member and supplies the hydraulic oil to the steering cylinder, the method includes: obtaining a speed of the work vehicle and a steering angle of the steering wheel; and decreasing a correction factor for correcting a deviation amount of actual steering angle information of the steering wheel with respect to target information as information on a target steering angle of the steering wheel with respect to an operation amount of the steering member when the speed of the work vehicle increases in a case where the steering angle of the steering wheel obtained based on the steering angle is in a predetermined range from a neutral position.

### FIELD

The present invention relates to a work vehicle with a steering wheel and a work vehicle control method.

### BACKGROUND

In a work vehicle such as a forklift including a steering wheel, a steering valve unit ejects hydraulic oil in response to the rotation of a handle used to operate the steering wheel. The ejected hydraulic oil is supplied to a steering cylinder so that the steering wheel is operated. The handle of the work vehicle is provided with a knob so that an operator can operate the knob by one hand while operating a working implement such as a fork. There is a case where the operator determines whether a steering angle of the steering wheel is located at a position corresponding to a forward moving posture depending on the position of the knob.

There is a case where the operation amount of the handle is deviated from the steering angle of the steering wheel. Due to this deviation, there is a case where a deviation occurs at the position of the knob of the handle when the work vehicle moves forward. A deviation between the operation amount of the handle and the steering angle of the steering wheel is caused by the leakage of hydraulic oil in accordance with a change in the load of the steering wheel and a difference in the amount of the hydraulic oil supplied to a steering cylinder in the case of the right swing and the left swing. A difference in the amount of the hydraulic oil supplied to the steering cylinder is caused by the individual difference of a steering valve unit. Patent Literature 1 discloses a technique of correcting a deviation between the operation amount of the handle and the steering angle of the steering wheel.

### CITATION LIST

### Patent Literature

Patent Literature 1: Japanese Laid-open Patent Publication No. 9-263258

### SUMMARY

### Technical Problem

If a correction factor per unit time (hereinafter, appropriately referred to as a correction factor) is set to a large value when a deviation between the operation amount of the handle and the steering angle of the steering wheel is corrected, there is a possibility that the steering wheel is operated more than the operation amount desired by the operator of the work vehicle when the handle is operated. As a result, there is a possibility that hunting is generated when the steering angle of the steering wheel is located at a neutral position. Further, when the correction factor is set to a large value in a low-speed traveling state so that the tire angle change amount with respect to the operation of the handle is large, the handle is operated to a small extent and hence the positioning is easy. However, when the correction factor is set to a large value in a high-speed traveling state, the steering wheel change amount with respect to a small operation amount of the handle increases. Thus, the vehicle moves largely in the left and right direction and hence the steering is difficult.

An object of an aspect of the present invention is to suppress hunting from being generated at a steering angle of the steering wheel in the vicinity of a neutral position and to suppress a steering wheel from being operated excessively in a high-speed travel state when a deviation between a handle operation amount and a steering angle of the steering wheel is corrected in a work vehicle of which a steering wheel is operated by a handle.

### Solution to Problem

According to a first aspect of the present invention, a work vehicle comprises: a steering cylinder which operates a steering wheel of a work vehicle by hydraulic oil supplied thereto; a steering member that receives an input for operating the steering wheel; a steering valve unit which is connected to the steering member and supplies the hydraulic oil to the steering cylinder; a first detector which detects an operation amount of the steering member; a second detector which detects a steering angle of the steering wheel; a third detector which detects a speed of the work vehicle; a first calculation unit which obtains target information as information of a target steering angle of the steering wheel with respect to the operation amount of the steering member detected by the first detector; a second calculation unit which obtains actual steering angle information as information corresponding to an actual steering angle of the steering wheel detected by the second detector; a correction unit which corrects a deviation amount between the target information and the actual steering angle information; and an adjustment unit which decreases a correction factor for the deviation amount of the correction unit when a speed of the work vehicle detected by the third detector increases in a case where the second detector detects that the steering angle of the steering wheel is in a predetermined range from a neutral position.

According to a first aspect of the present invention, in the first aspect, the work vehicle according to claim 1, further comprises: a third calculation unit which obtains a deviation between the target information and the actual steering angle information, wherein the correction unit changes the correction factor in accordance with the deviation obtained by the third calculation unit.

According to a first aspect of the present invention, in the aspect 1 or 2, wherein the target information indicates a target stroke of the steering cylinder with respect to the operation amount of the steering member detected by the first detector, and the actual steering angle information indicates an actual stroke of the steering cylinder with respect to the actual steering angle.

According to a first aspect of the present invention, the work vehicle according to any one of the aspects 1 to 3, further comprises: an adjustment device which adjusts an amount of the hydraulic oil supplied to the steering cylinder, wherein the correction unit changes the amount of the hydraulic oil supplied to the steering cylinder by controlling the adjustment device.

According to a first aspect of the present invention, the work vehicle according to any one of the aspects 1 to 4, wherein the target information with respect to the operation amount of the steering member detected by the first detector is obtained by using an upper limit of a change in the amount of the hydraulic oil supplied from the steering valve unit to the steering cylinder.

According to a first aspect of the present invention, the work vehicle according to any one of the aspects 1 to 5, wherein the adjustment unit linearly changes the correction factor at the threshold value or more.

According to a first aspect of the present invention, a method of controlling a work vehicle including a steering cylinder which operates a steering wheel of a work vehicle by hydraulic oil supplied thereto, a steering member which receives an input for operating the steering wheel, and a steering valve unit which is connected to the steering member and supplies the hydraulic oil to the steering cylinder, the method of controlling the work vehicle comprises: obtaining a speed of the work vehicle and a steering angle of the steering wheel; and decreasing a correction factor for correcting a deviation amount of actual steering angle information of the steering wheel with respect to target information as information on a target steering angle of the steering wheel with respect to an operation amount of the steering member when the speed of the work vehicle increases in a case where the steering angle of the steering wheel obtained based on the steering angle is in a predetermined range from a neutral position.

An aspect of the present invention is able to suppress hunting from being generated at a steering angle of the steering wheel in the vicinity of a neutral position and to suppress a steering wheel from being operated excessively by setting the correction factor to a small value in a high-speed travel state when a deviation between a handle operation amount and a steering angle of the steering wheel is corrected in a work vehicle of which a steering wheel is operated by a handle.

### BRIEF DESCRIPTION OF DRAWINGS

FIG. 1 is a diagram illustrating an entire configuration of a work vehicle according to an embodiment.

FIG. 2 is a diagram illustrating a steering system of a forklift illustrated in FIG. 1.

FIG. 3 is a diagram illustrating an example of a detection value of a handle angle sensor.

FIG. 4 is a diagram illustrating an example of a detection value of a steering angle sensor.

FIG. 5 is a control block diagram of a control device.

FIG. 6 is a table for obtaining a correction factor by a correction unit.

FIG. 7 is a diagram illustrating an example of a relation between a correction factor and angular velocity of a handle.

FIG. 8 is a diagram illustrating an example of a relation between a correction factor and a deviation.

FIG. 9 is a table for obtaining a gain by an adjustment unit.

FIG. 10 is a diagram illustrating an example of a relation between a gain and a speed of the forklift.

FIG. 11 is a diagram illustrating an example of a relation between a gain and an actual stroke.

FIG. 12 is a diagram illustrating a case where a steering angle of a steering wheel is in a predetermined range from a neutral position.

FIG. 13 is a diagram illustrating a case where the steering angle of the steering wheel is in a predetermined range from a neutral position.

FIG. 14 is a flowchart in which a control device performs a work vehicle control method according to the embodiment.

### DESCRIPTION OF EMBODIMENTS

Hereinafter, an embodiment of the present invention will be described with reference to the drawings.

<Work Vehicle>

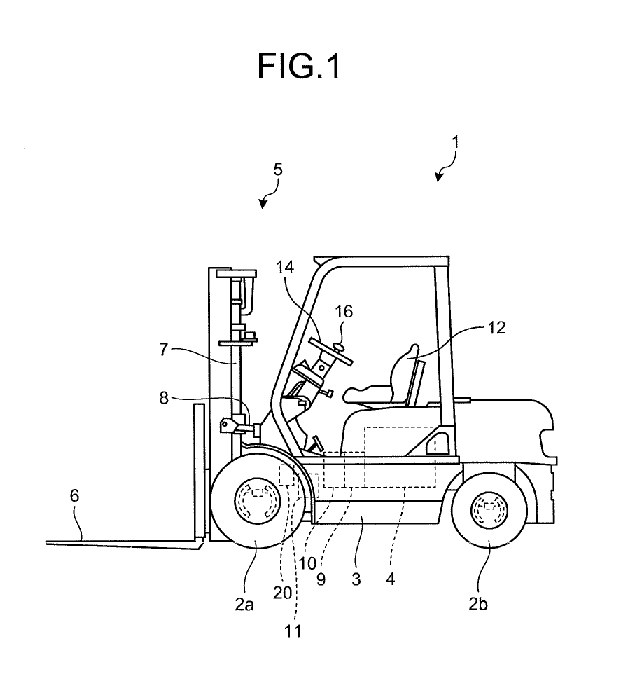

FIG. 1 is a diagram illustrating an entire configuration of a work vehicle according to an embodiment. In the description below, an example will be described in which a forklift 1 is a work vehicle, but the work vehicle is not limited to the forklift. The forklift 1 includes a vehicle body 3 including a drive wheel 2a and a steering wheel 2b, a working implement 5, and a control device 20. In the forklift 1, a direction from a driver seat 12 toward a handle 14 as a steering member indicates a forward direction and a direction from the handle 14 toward the driver seat 12 indicates a backward direction. The working implement 5 is provided at the front side of the vehicle body 3.

The vehicle body 3 is equipped with an engine 4 as an example of an internal combustion engine and a working implement hydraulic pump 9 and a traveling hydraulic pump 10 driven by the engine 4. The working implement hydraulic pump 9 and the traveling hydraulic pump 10 are variable displacement pumps. The engine 4 is a power source of the forklift. The engine 4 is, for example, a diesel engine, but the present invention is not limited thereto. The forklift 1 may include an electric motor as a power source instead of the engine 4.

The working implement 5 includes a fork 6 which places a load thereon, a lifting cylinder 7 which elevates the fork 6, and a tilting cylinder 8 which tilts the fork 6.

An output shaft of the engine 4 is connected to the working implement hydraulic pump 9 and the traveling hydraulic pump 10. The working implement hydraulic pump 9 and the traveling hydraulic pump 10 are driven by the engine 4 through the output shaft. The drive wheel 2a is driven by a hydraulic motor 11. The steering wheel 2b is steered by the handle 14, that is, the direction is changed by the handle. The handle 14 includes a knob 16. The handle 14 receives an input for operating the steering wheel 2b. The operator of the forklift 1 can operate the handle 14 using one hand by gripping the knob 16 while performing a load handling operation of lifting or tilting the fork 6.

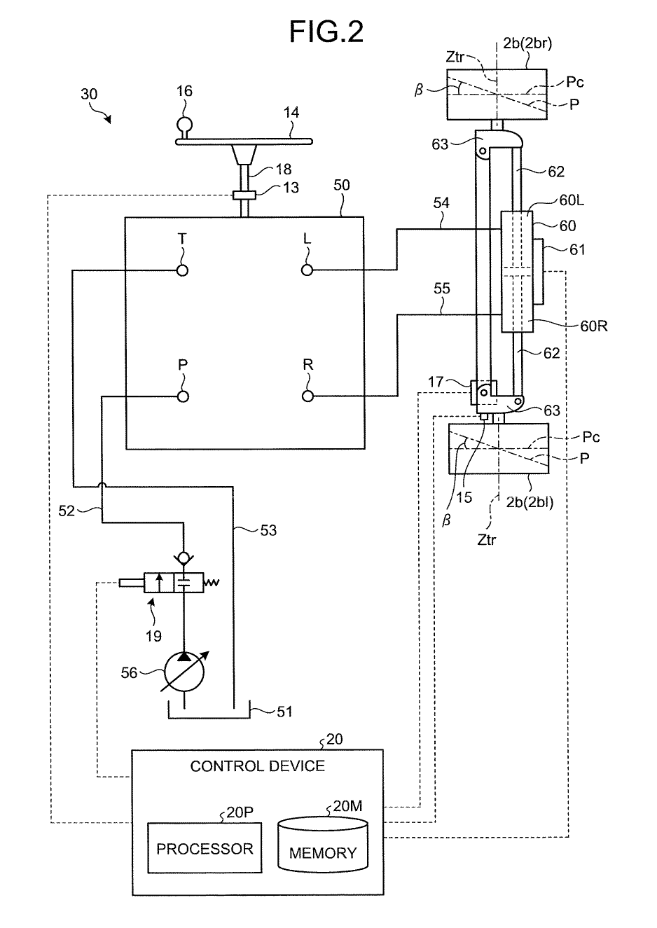

FIG. 2 is a diagram illustrating a steering system 30 of the forklift 1 illustrated in FIG. 1. The steering system 30 is a hydraulic system which operates the steering wheel 2b by hydraulic oil. The steering system 30 is mounted on the forklift 1 and steers the steering wheel 2b. The steering system 30 includes the handle 14, a steering valve unit 50, a steering cylinder 60, a solenoid valve 19 as an adjustment device, and the control device 20.

The steering valve unit 50 is connected to the handle 14 through a shaft 18. When the handle 14 rotates, the steering valve unit 50 is operated. The steering valve unit 50 is a device obtained by integrating a manual direction changing valve and a servo feedback metering mechanism. The steering valve unit 50 operates the steering cylinder 60 by supplying the hydraulic oil supplied from a hydraulic pump 56 to the steering cylinder 60. When the steering cylinder 60 is operated, the steering wheels 2b and 2b are operated. In this way, the steering valve unit 50 operates the steering wheels 2b and 2b through the steering cylinder 60.

When the hydraulic oil is supplied to the steering cylinder 60, the steering wheel 2b of the forklift 1 as the pair of steering wheels 2b and 2b of the embodiment is operated. The steering cylinder 60 is, for example, a hydraulic cylinder. The steering cylinder 60 is formed so that a cylinder rod 62 protrudes from both end portions thereof. The cylinder rods 62 and 62 are connected to members 63 and 63 operating the steering wheels 2b and 2b. When the steering valve unit 50 is operated by the handle 14, the hydraulic oil is supplied from the steering valve unit 50 to the steering cylinder 60. Then, when one of the cylinder rods 62 is lengthened, the other thereof is shortened and hence the pair of steering wheels 2b and 2b respectively move in the same direction. In this way, the steering wheels 2b and 2b are steered by the operation of the handle 14.

The operation amount of the handle 14 is detected by a handle angle sensor 13 as a first detector. The handle angle sensor 13 detects the rotation angle of the handle 14 when the handle 14 rotates about the shaft 18. The rotation angle of the handle 14 detected by the handle angle sensor 13 is the operation amount of the handle 14. The handle angle sensor 13 is connected to the control device 20. The control device 20 acquires the detection value of the handle angle sensor 13 and uses the detection value in a working machine control method according to the embodiment. The working machine control method according to the embodiment is a method of correcting the position of the knob 16 when the forklift 1 moves forward.

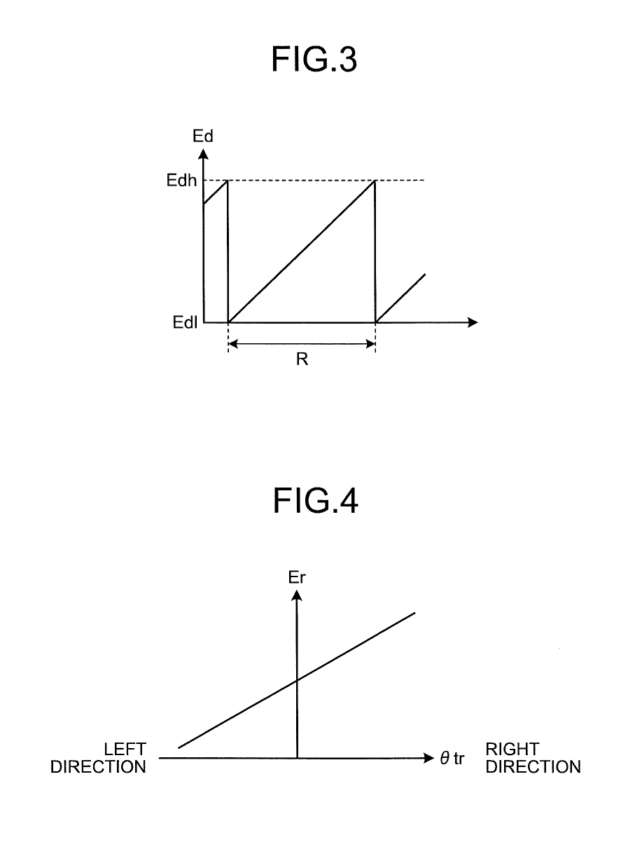

FIG. 3 is a diagram illustrating an example of the detection value of the handle angle sensor 13. The handle angle sensor 13 outputs a voltage Ed in response to the position of the handle 14 in the rotation direction. When the handle 14 rotates by one revolution, the voltage Ed output from the handle angle sensor 13 changes from a voltage Edl to a voltage Edh. The symbol R in FIG. 3 indicates a state in which the handle 14 rotates by one revolution, that is, 360°. When the handle 14 rotates in a first direction, for example, a clockwise direction, the voltage Ed output from the handle angle sensor 13 increases as the rotation amount of the handle 14 increases. When the handle 14 rotates in a second direction, for example, a counter-clockwise direction, the voltage Ed output from the handle angle sensor 13 decreases as the rotation amount of the handle 14 increases. For this reason, the rotation direction of the handle 14 is distinguished depending on whether the voltage Ed output from the handle angle sensor 13 increases or smaller in accordance with the elapse of time.

A hydraulic oil supply passage 52 and a hydraulic oil collection passage 53 are connected to the steering valve unit 50. The hydraulic oil supply passage 52 is connected to a port P of the steering valve unit 50. The hydraulic oil ejected from the hydraulic pump 56 is led to the steering valve unit 50 through the hydraulic oil supply passage 52. The hydraulic oil discharged from the steering valve unit 50 is led to a working oil tank 51 through the hydraulic oil collection passage 53. The hydraulic oil collection passage 53 is connected to a port T of the steering valve unit 50. The hydraulic pump 56 is driven by the engine 4 illustrated in FIG. 1 so that the hydraulic oil is suctioned from the working oil tank 51 and is supplied to the steering valve unit 50. The hydraulic pump 56 is a variable displacement pump, but the present invention is not limited to such a type.

The steering valve unit 50 and the steering cylinder 60 are connected to each other by a first hydraulic oil passage 54 and a second hydraulic oil passage 55. The first hydraulic oil passage 54 is connected to a first hydraulic oil chamber 60L of the steering cylinder 60 and the second hydraulic oil passage 55 is connected to a second hydraulic oil chamber 60R of the steering cylinder 60. The first hydraulic oil passage 54 is connected to a port L of the steering valve unit 50. The second hydraulic oil passage 55 is connected to a port R of the steering valve unit 50.

When the hydraulic oil is supplied to the first hydraulic oil chamber 60L, the hydraulic oil is discharged from the second hydraulic oil chamber 60R. When the hydraulic oil is supplied to the first hydraulic oil chamber 60L, the cylinder rod 62 is pulled into the first hydraulic oil chamber 60L and the cylinder rod 62 protrudes from the second hydraulic oil chamber 60R. When the hydraulic oil is supplied to the second hydraulic oil chamber 60R, the cylinder rod 62 is pulled into the second hydraulic oil chamber 60R and the cylinder rod 62 protrudes from the first hydraulic oil chamber 60L.

The operation amount of the steering cylinder 60, more specifically, the operation amount of the cylinder rod 62 is detected by a stroke sensor 61 as an operation amount detector. The stroke sensor 61 is connected to the control device 20. The control device 20 acquires the detection value of the stroke sensor 61 and uses the detection value in the working machine control method according to the embodiment.

The steering cylinder 60 has a configuration in which the operation amount of the cylinder rod 62 changes in accordance with the amount of the hydraulic oil supplied from the steering valve unit 50 to the first hydraulic oil chamber 60L or the second hydraulic oil chamber 60R. Since the operation amount of the cylinder rod 62 changes, the operation amount of each of the steering wheels 2b and 2b, that is, the steering amount also changes. The steering amount of each of the steering wheels 2b and 2b is indicated by a steering angle β. The steering angle β indicates an inclination angle of a meridian plane P of each of the steering wheels 2b and 2b and indicates an inclination angle based on a meridian plane Pc when the steering wheels 2b and 2b are in a neutral state. The meridian plane P is a plane orthogonal to the rotation center axis Ztr of the steering wheel 2b and passing through the center of the steering wheel 2b in the width direction (a direction parallel to the rotation center axis Ztr). When the steering wheels 2b and 2b are in a neutral state, the forklift 1 moves forward.

The steering angle β is detected by a steering angle sensor 17 as a second detector. The steering angle sensor 17 is connected to the control device 20. The control device 20 acquires the detection value of the steering angle sensor 17 and uses the detection value in the working machine control method according to the embodiment. In the embodiment, the steering angle sensor 17 detects the steering angle β of one steering wheel 2b. Due to the structure of the steering mechanism, the steering angles β of the right steering wheel 2b and the left steering wheel 2b operated in the same direction are different from each other, but the control device 20 may use one steering angle β only for the control.

FIG. 4 is a diagram illustrating an example of the detection value of the steering angle sensor 17. The steering angle sensor 17 outputs a voltage Er in response to the steering angle β of the steering wheel 2b. The steering angle sensor 17 outputs the voltage Ed when the steering wheel 2b is steered in a first direction, for example, a right direction. In this case, the voltage Ed increases as the steering angle β increases. The steering angle sensor 17 outputs the voltage Ed when the steering wheel 2b is steered in a second direction, for example, a left direction. In this case, the voltage Ed decreases, that is, the absolute value increases as the steering angle β increases. A direction in which the steering wheel 2b is steered is distinguished depending on, for example, whether a difference between the current value and the last value of the voltage Ed output from the steering angle sensor 17 is positive or negative. Specifically, when a difference between the current value and the last value of the voltage Ed is positive, the steering direction of the steering wheel 2b is a right direction. Meanwhile, when a difference between the current value and the last value of the voltage Ed is negative, the steering direction of the steering wheel 2b is a left direction.

When the forklift 1 travels, the steering wheels 2b and 2b rotate by the friction against a ground surface. For this reason, the speed of the forklift 1 is detected from the rotation speed of the steering wheel 2b. A vehicle speed sensor 15 as a third detector detects the rotation speed of the steering wheel 2b. Since the rotation speed of the steering wheel 2b is the speed of the forklift 1, the vehicle speed sensor 15 detects the speed of the forklift 1. The vehicle speed sensor 15 is connected to the control device 20. The control device 20 acquires the detection value of the vehicle speed sensor 15, that is, the rotation speed of the steering wheel 2b and uses the detection value in the working machine control method according to the embodiment.

The solenoid valve 19 is provided in the hydraulic oil supply passage 52. The solenoid valve 19 is opened or closed by the control device 20. When the solenoid valve 19 is opened, the hydraulic oil is supplied from the hydraulic pump 56 to the steering valve unit 50 through the hydraulic oil supply passage 52. When the solenoid valve 19 is closed, the supply of the hydraulic oil from the hydraulic pump 56 to the steering valve unit 50 is stopped. When a ratio of opening and closing the solenoid valve 19, that is, a duty ratio is changed, the amount of the hydraulic oil supplied from the hydraulic pump 56 to the steering valve unit 50 is changed.

When the steering valve unit 50 receives an input from the handle 14, the steering valve unit 50 supplies the hydraulic oil to the steering cylinder 60. When the solenoid valve 19 is opened or closed at this timing, the amount of the hydraulic oil supplied from the hydraulic pump 56 to the steering valve unit 50 is changed and hence the amount of the hydraulic oil supplied to the steering cylinder 60 is changed. In this way, the solenoid valve 19 adjusts the amount of the hydraulic oil supplied to the steering cylinder 60.

The control device 20 includes a processor 20P and a memory 20M. The control device 20 is, for example, a computer and is a device which performs various processes relating to the control of the forklift 1. Various processes relating to the control of the forklift 1 include a process relating to the working machine control method according to the embodiment. The processor 20P is also referred to as a CPU (Central Processing Unit), a processing device, a calculation device, a microprocessor, a microcomputer, or a DSP (Digital Signal Processor). The memory 20M corresponds to a volatile or non-volatile semiconductor memory such as a RAM (Random Access Memory), a ROM (Read Only Memory), a flash memory, an EPROM (Erasable Programmable Read Only Memory), and an EEPROM (Electrically Erasable Programmable Read Only Memory), a magnetic disc, a flexible disc, an optical disc, a compact disc, a mini disc, and a DVD (Digital Versatile Disc).

The processor 20P reads a computer program for controlling the forklift 1 and a computer program for realizing the working machine control method according to the embodiment stored in the memory 20M and performs a command described therein to control the forklift 1. The memory 20M stores data necessary for the above-described computer program and the control of the forklift 1.

<Control Block of Control Device 20>

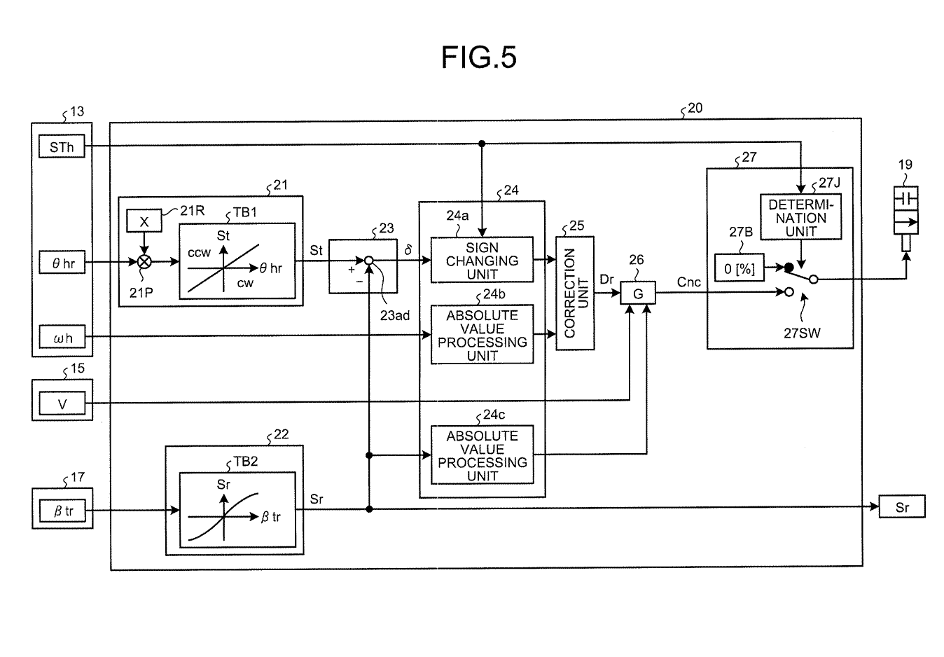

FIG. 5 is a control block diagram of the control device 20. The control device 20 includes a first calculation unit 21, a second calculation unit 22, a correction unit 25, and an adjustment unit 26. The first calculation unit 21 obtains target information as the information of the steering angle β as the target of the steering wheel 2b with respect to a rotation angle θhr of the handle 14 detected by the handle angle sensor 13. The second calculation unit 22 obtains actual steering angle information as the information corresponding to an actual steering angle βtr of the steering wheel 2b detected by the steering angle sensor 17. The correction unit 25 corrects a deviation amount of the actual steering angle information with respect to the target information. If the steering angle sensor 17 detects a state in which the steering angle of the steering wheel 2b is in a predetermined range from a neutral position when the speed of the forklift 1 detected by the vehicle speed sensor 15 is equal to or larger than a threshold value, the adjustment unit 26 decreases a correction factor Dr for the deviation amount in the correction unit 25.

The control device 20 further includes a third calculation unit 23, a pre-processing unit 24, and a switching unit 27. The third calculation unit 23 obtains a deviation δ between the target information and the actual steering angle information. The correction unit 25 changes the correction factor in response to the deviation δ obtained by the third calculation unit 23. The pre-processing unit 24 processes the information acquired from the third calculation unit 23, the handle angle sensor 13, and the second calculation unit 22 into a form which can be used in the correction unit 25 and gives the processed information to the correction unit 25. The switching unit 27 switches a correction instruction value Cnc or a non-correction instruction value output from the adjustment unit 26 in response to the state of the handle 14 and outputs the result to the solenoid valve 19.

The first calculation unit 21 includes a constant giving unit 21R, a multiplying unit 21P, and a target information determination table TB1. The constant giving unit 21R gives a constant X to be multiplied by the rotation angle θhr of the handle 14 detected by the handle angle sensor 13 to the multiplying unit 21P. The multiplying unit 21P multiplies the constant X by the rotation angle θhr of the handle 14 and gives the result to the target information determination table TB1. When the constant X is 1, the multiplying unit 21P gives the rotation angle θhr of the handle 14 detected by the handle angle sensor 13 to the target information determination table TB1. The constant X is used to correct the detection value of the handle angle sensor 13, for example, when the detection value of the handle angle sensor 13 is changed from a designed value in accordance with a change in environment and a change in time of the handle angle sensor 13.

The target information determination table TB1 describes a relation between the rotation angle θhr of the handle 14 and a target stroke St of the steering cylinder 60. The target stroke St indicates target information. The target information determination table TB1 outputs the target stroke St of the steering cylinder 60 in response to the multiplying result of the multiplying unit 21P to the third calculation unit 23.

A relation between the rotation angle θhr of the handle 14 and the target stroke St of the steering cylinder 60 described in the target information determination table TB1 can be obtained in consideration of a change in the steering valve unit 50. Specifically, the target stroke St for the rotation angle θhr of the handle 14 detected by the handle angle sensor 13 is obtained by using the upper limit of a change in the amount of the hydraulic oil supplied from the steering valve unit 50 to the steering cylinder 60. Then, an obtained relation between the rotation angle θhr of the handle 14 and the target stroke St is described in the target information determination table TB1.

When a deviation between the rotation angle θhr of the handle 14 and the steering angle β of each of the steering wheels 2b and 2b is corrected, the control device 20 supplies the hydraulic oil from the solenoid valve 19 to the steering valve unit 50 and compensates the insufficient amount of the hydraulic oil supplied to the steering cylinder 60. That is, a deviation between the rotation angle θhr of the handle 14 and the steering angle β of each of the steering wheels 2b and 2b cannot be corrected in a state where the hydraulic oil supplied to the steering cylinder 60 is not insufficient.

In the embodiment, the target information determination table TB1 is obtained by using the upper limit of a change in the amount of the hydraulic oil supplied from the steering valve unit 50. The amount of the hydraulic oil actually supplied from the steering valve unit 50 is smaller than the above-described upper limit. For this reason, the absolute value of the target stroke St of the steering cylinder 60 obtained when using the steering valve unit 50 actually mounted on the forklift 1 becomes smaller than that of the target stroke St described in the target information determination table TB1. As a result, even when the amount of the hydraulic oil supplied from the steering valve unit 50 changes, the control device 20 can correct a deviation between the rotation angle θhr of the handle 14 and the steering angle β of each of the steering wheels 2b and 2b by compensating the insufficient amount of the hydraulic oil supplied to the steering cylinder 60.

The upper limit of the change can be set to, for example, a value obtained by adding 3×σ to the average value of the amount of the hydraulic oil supplied from the plurality of steering valve units 50. σ indicates a standard deviation in the hydraulic oil supplied from the plurality of steering valve units 50. The average value and the standard deviation σ of the amount of the hydraulic oil supplied from the plurality of steering valve units 50 are obtained from the information of the manufacturing irregularity of the steering valve unit 50. These values are generally obtained as the specification of the steering valve unit 50. The upper limit of the change is not limited thereto.

As described above, the target information indicates the information of the steering angle β as the target of the steering wheel 2b with respect to the rotation angle θhr of the handle 14. That is, the target information indicates the information for determining the operation amount of the steering wheel 2b with respect to the operation amount of the handle 14.

When the stroke of the steering cylinder 60 is determined, the steering angle β of the steering wheel 2b is also determined at the same time. For this reason, the steering angle β as the target of the steering wheel 2b is determined by the target stroke St. In the embodiment, the target stroke St indicates target information.

The second calculation unit 22 includes an actual steering angle information determination table TB2. The actual steering angle information determination table TB2 describes a relation between the actual steering angle βtr and a stroke Sr of the steering cylinder 60. That is, the actual steering angle information determination table TB2 indicates a table for converting the actual steering angle βtr detected by the steering angle sensor 17 into the stroke Sr as the operation amount of the steering cylinder 60. In the embodiment, the stroke St of the steering cylinder 60 corresponding to the actual steering angle βtr becomes the actual steering angle information. The stroke Sr of the steering cylinder 60 may be obtained from the relation of the link of the steering mechanism or may be a value detected by the stroke sensor 61 illustrated in FIG. 2. In the description below, the stroke Sr will be appropriately referred to as the actual stroke Sr. The actual stroke Sr indicates the actual steering angle information.

The third calculation unit 23 includes an addition/subtraction unit 23ad. The addition/subtraction unit 23ad subtracts the actual stroke Sr output from the second calculation unit 22 from the target stroke St output from the first calculation unit 21. By this calculation, the third calculation unit 23 obtains a deviation δ between the target information and the actual steering angle information and outputs the deviation to the pre-processing unit 24.

The pre-processing unit 24 includes a sign changing unit 24a and absolute value processing units 24b and 24c. The pre-processing unit 24 acquires the deviation δ from the third calculation unit 23, acquires an operation state STh of the handle 14 and an angular velocity ωh of the handle 14 from the handle angle sensor 13, and acquires the actual stroke Sr from the second calculation unit 22. The operation state STh of the handle 14 indicates the information representing a clockwise direction (CW, a first direction), a counter-clockwise direction (CCW, a second direction) or a stop state of the handle 14.

In the embodiment, the control device 20 performs a correction using the solenoid valve 19 in the case where the handle 14 rotates in the clockwise direction and the actual stroke Sr is smaller than the target stroke St and a case where the handle 14 rotates in the counter-clockwise direction and the actual stroke Sr is larger than the target stroke St. That is, when the absolute value of the actual stroke Sr is smaller than the absolute value of the target stroke St, a correction using the solenoid valve 19 is performed. For this reason, the sign changing unit 24a multiplies the deviation δ by +1 or −1 and gives the result to the correction unit 25. Specifically, when the handle 14 rotates in the clockwise direction, the sign changing unit 24a multiplies the deviation δ by +1 and gives the result to the correction unit 25. When the handle 14 rotates in the counter-clockwise direction, the sign changing unit 24a multiplies the deviation δ by −1 and gives the result to the correction unit 25.

The absolute value processing unit 24b converts the value of the angular velocity ωh of the handle 14 acquired from the handle angle sensor 13 into an absolute value and gives the result to the correction unit 25. The angular velocity ωh of the handle 14 can be obtained by differentiating the rotation angle θhr of the handle 14 in time. The absolute value processing unit 24b converts the value of the actual stroke Sr acquired from the second calculation unit 22 into an absolute value and gives the result to the adjustment unit 26. In the embodiment, the handle angle sensor 13 outputs the operation state STh of the handle 14, that is, the information representing the clockwise direction, the counter-clockwise direction, or the stop state of the handle 14, the angular velocity ωh thereof, and the rotation angle θhr thereof. The present invention is not limited to such a configuration. The handle angle sensor 13 may output the rotation amount of the handle 14 as, for example, the number of pulses. The operation state STh, the angular velocity ωh, and the rotation angle θhr of the handle 14 may be calculated from the rotation amount of the handle 14 by a device other than the handle angle sensor 13, for example, the control device 20.

In the embodiment, the steering angle sensor 17 outputs the actual steering angle βtr, but the present invention is not limited thereto. The steering angle sensor 17 outputs the operation amount of the steering wheel 2b as, for example, the number of pulses. The actual steering angle βtr may be calculated from the operation amount of the steering wheel 2b by a device other than the steering angle sensor 17, for example, the control device 20.

In the embodiment, the vehicle speed sensor 15 outputs a speed V of the forklift 1, but the present invention is not limited thereto. The vehicle speed sensor 15 outputs the rotation number of the steering wheel 2b as, for example, the number of pulses. The speed of the forklift 1 may be calculated from the rotation number and the circumferential length of the steering wheel 2b by a device other than the vehicle speed sensor 15, for example, the control device 20.

The correction unit 25 obtains the correction factor Dr by using the absolute value of the deviation δ received from the sign changing unit 24a of the pre-processing unit 24 and the angular velocity ωh received from the absolute value processing unit 24b of the pre-processing unit 24 and outputs the result to the adjustment unit 26. In the embodiment, the correction factor Dr indicates the duty ratio of the solenoid valve 19. The duty ratio of the solenoid valve 19 is expressed as To/T when the valve opening time of the solenoid valve 19 is indicated by To and the time in which the solenoid valve 19 is closed from the opened state and is opened again is indicated by T. In this case, T corresponds to one period of the operation of the solenoid valve 19. Further, when the valve opening time of the solenoid valve 19 is indicated by To and the valve closing time thereof is indicated by Tc, the duty ratio is expressed by To/(To+Tc).

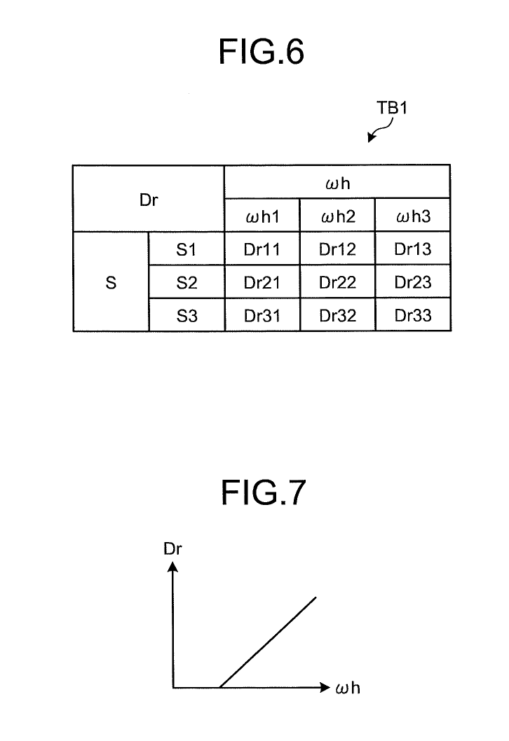

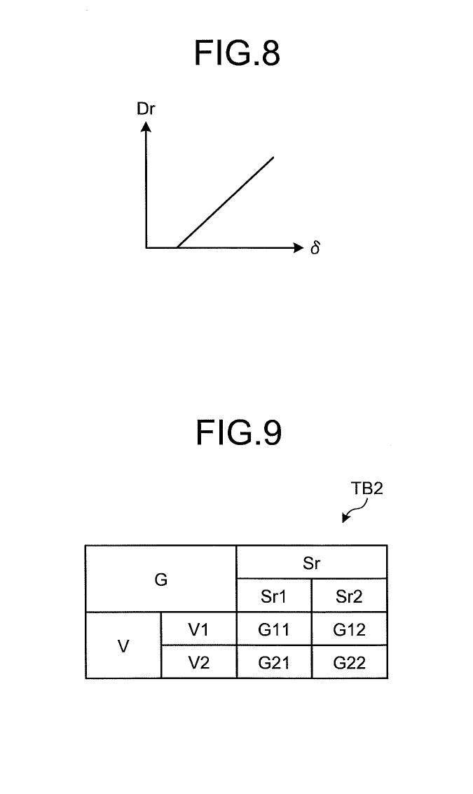

FIG. 6 is the table TB1 for obtaining the correction factor Dr by the correction unit 25. FIG. 7 is a diagram illustrating an example of a relation between the correction factor Dr and the angular velocity ωh of the handle 14. FIG. 8 is a diagram illustrating an example of a relation between the correction factor Dr and the deviation δ. The correction factor Dr is changed based on the angular velocity ωh and the deviation δ of the handle 14.

In the table TB1, the angular velocity ωh increases in order of ωh1, ωh2, and ωh3. The deviation δ increases in order of δ1, δ2, and δ3. The correction factor Dr increases relatively when the angular velocity ωh increases. With such a configuration, when the handle 14 is operated fast, the amount of the hydraulic oil supplied to the steering valve unit 50 through the solenoid valve 19 increases.

Further, the correction factor Dr increases relatively when the deviation δ increases. With such a configuration, the amount of the hydraulic oil supplied to the steering valve unit 50 through the solenoid valve 19 increases as the absolute value of the actual stroke Sr of the steering cylinder 60 becomes smaller than the absolute value of the target stroke St. As a result, if the control device 20 performs a correction using the solenoid valve 19 when the absolute value of the actual stroke Sr of the steering cylinder 60 becomes smaller than the absolute value of the target stroke St, the absolute value of the actual stroke Sr can be promptly set to the absolute value of the target stroke St.

When an operator rotates the handle 14 relatively slowly, the deviation δ decreases relatively. If the correction factor Dr in the case where the deviation δ is relatively large is used when the deviation δ decreases relatively, there is a possibility that the steering angle β noticeably changes more. The correction unit 25 increases the correction factor Dr relatively when the deviation δ increases relatively. That is, the correction unit decreases the correction factor Dr relatively when the deviation δ decreases relatively. Accordingly, it is possible to suppress an increase in the change of the steering angle β when the operator rotates the handle 14 relatively slowly.

In the table TB1, correction factors Dr31, DR32, and DR33 increase in this order and correction factors Dr21, DR22, and DR23 increase in this order. In the table TB1, correction factors Dr11, DR12, and DR13 may increase in this order in the same way. Further, in the table TB1, the correction factors Dr13, DR23, and DR33 increase in this order and the correction factors Dr12, DR22, and DR32 increase in this order. In the table TB1, the correction factors Dr11, DR21, and DR31 may increase in this order in the same way.

In the table TB1, the angular velocity ωh and the deviation δ are discrete, but the correction unit 25 may obtain the correction factor Dr in the range in which these values do not exist by the interpolation using the angular velocity ωh and the deviation δ described in the table TB1. The interpolation is, for example, a linear interpolation, but the present invention is not limited thereto. By the linear interpolation, the correction factor Dr changes linearly with respect to the angular velocity ωh and the deviation δ as illustrated in FIGS. 7 and 8. With such a configuration, it is possible to suppress an abrupt change in the correction factor Dr, that is, an abrupt change in the amount of the hydraulic oil supplied to the steering cylinder 60.

The adjustment unit 26 generates the correction instruction value Cnc by multiplying a gain G by the correction factor Dr received from the correction unit 25 and gives the result to the switching unit 27. The adjustment unit 26 changes the gain G based on the speed V of the forklift 1 and the absolute value of the actual stroke Sr.

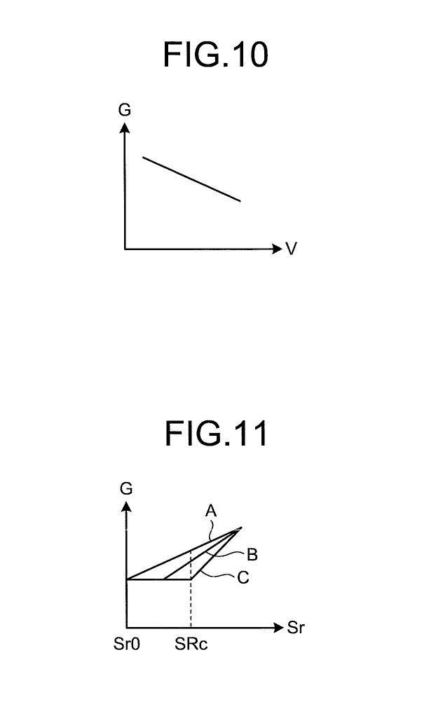

FIG. 9 is the table TB2 for obtaining the gain G by the adjustment unit 26. FIG. 10 is a diagram illustrating an example of a relation between the gain G and the speed V of the forklift 1. FIG. 11 is a diagram illustrating an example of a relation between the gain G and the actual stroke Sr. The actual stroke Sr of FIG. 11 is an absolute value.

In the table TB2, the actual stroke Sr decreases in order of Sr2 and Sr1. The speed V increases in order of V1 and V2. The gain G decreases when the actual stroke Sr decreases. A case where the actual stroke Sr is small indicates a case where the steering angle of each of the steering wheels 2b and 2b is in a predetermined range from the neutral position. A case where the steering angle of each of the steering wheels 2b and 2b is in a predetermined range from the neutral position also includes a case where the steering angle of each of the steering wheels 2b and 2b is in the neutral position. When the steering angle of each of the steering wheels 2b and 2b is in a predetermined range from the neutral position, the gain G becomes smaller than the case where the steering angle of each of the steering wheels 2b and 2b is outside a predetermined range from a neutral position. In the table TB2, for example, the steering angle of each of the steering wheels 2b and 2b is in a predetermined range from the neutral position in the case of the actual stroke Sr1 and the steering angle of each of the steering wheels 2b and 2b is outside a predetermined range from the neutral position in the case of the actual stroke Sr2. In this case, for example, gains G22 and G21 decrease in this order. In the embodiment, the gains G12 and G11 are equal to each other, but may decrease in this order.

With such a configuration, when the steering angle of each of the steering wheels 2b and 2b is in a predetermined range from the neutral position, the gain G decreases. Since the adjustment unit 26 multiplies the gain G by the correction factor Dr, the amount of the hydraulic oil supplied to the steering valve unit 50 through the solenoid valve 19 is small when the steering angle of each of the steering wheels 2b and 2b is in a predetermined range from the neutral position. For that reason, the control device 20 can suppress the steering wheel 2b from being operated excessively more than the amount desired by the operator when the operator operates the handle 14. As a result, the control device 20 can suppress hunting from being generated when the steering angle of each of the steering wheels 2b and 2b is in the vicinity of the neutral position while the forklift 1 travels.

The gain G decreases when the speed V increases. Since the adjustment unit 26 multiplies the gain G by the correction factor Dr, the amount of the hydraulic oil supplied to the steering valve unit 50 through the solenoid valve 19 decreases when the speed V increases. With such a configuration, the control device 20 can suppress the steering wheel 2b from being operated excessively more than the amount desired by the operator when the operator operates the handle 14 while the forklift 1 travels at a high speed. Further, when the speed of the forklift 1 is relatively high, the control device can suppress hunting from being generated when the steering angle of each of the steering wheels 2b and 2b is in the vicinity of the neutral position. In the table TB2, for example, the gains G11 and G21 decrease in this order. In the embodiment, the gains G12 and G22 are equal to each other, but may decrease in this order.

In the table TB2, the actual stroke Sr and the speed V are discrete, but the adjustment unit 26 may obtain the gain G in the range in which these values do not exist by the interpolation using the actual stroke Sr and the speed V described in the table TB2. The interpolation is, for example, a linear interpolation, but the present invention is not limited thereto. By the linear interpolation, the gain G changes linearly with respect to the actual stroke Sr and the speed V as indicated by the solid lines A of FIGS. 10 and 11. With such a configuration, it is possible to suppress an abrupt change in the gain G, that is, an abrupt change in the amount of the hydraulic oil supplied to the steering cylinder 60.

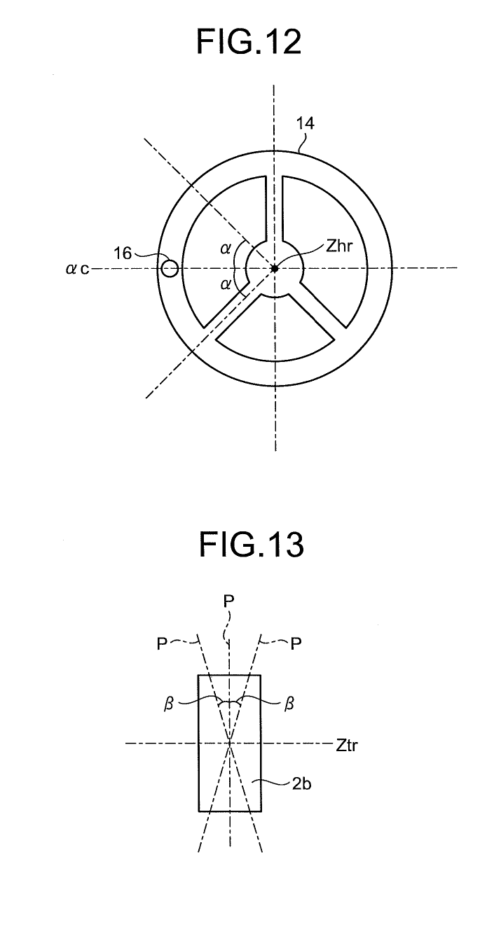

FIGS. 12 and 13 are diagrams illustrating a case where the steering angle of each of the steering wheels 2b and 2b is in a predetermined range from the neutral position. A case where the steering angle of each of the steering wheels 2b and 2b is at the neutral position indicates a case where the handle 14 is located at the steering angle of the neutral position. A case where the steering angle of each of the steering wheels 2b and 2b is in a predetermined range from the neutral position indicates a case where the handle 14 is in a predetermined range from the neutral position in each of the clockwise direction and the counter-clockwise direction. In the example illustrated in FIG. 12, the knob 16 is located at the neutral position. A case where the handle 14 is rotated in the clockwise direction will be referred to as “+” (plus) and a case where the handle is rotated in the counter-clockwise direction will be referred to as “−” (minus). In this example, a position in which the handle 14 is located at the neutral position is indicated by αc° and a range in which the handle 14 moves from +α° to −α° based on αc° will be referred to as a predetermined range from the neutral position of each of the steering angles of the steering wheels 2b and 2b. “α” and “αc” indicate the degree of the center angle about a rotation center axis Zhr of the handle 14. “α” is a value larger than 0 and equal to or smaller than 90 and is generally from about 20 to 30.

When the steering angle β of the steering wheel 2b illustrated in FIG. 13 is used, a case where the steering angle of each of the steering wheels 2b and 2b is located at the neutral position indicates a case where the steering angle β is 0°. A case where the steering angle of each of the steering wheels 2b and 2b is in a predetermined range from the neutral position indicates a case where the steering angle β is in the range of 2° to 6° and desirably 2° to 4° in the left and right direction.

In the example illustrated in FIG. 11, the steering angle of each of the steering wheels 2b and 2b is located at the neutral position in the case of an actual stroke Sr0. In the example illustrated in FIG. 11, a range from the actual stroke Sr1 to an actual stroke Src indicates a predetermined range from the neutral position of the steering angle of each of the steering wheels 2b and 2b. As indicated by the solid line A, when the steering angle of each of the steering wheels 2b and 2b is in a predetermined range from the neutral position, the gain G becomes smaller than the case where the steering angle of each of the steering wheels 2b and 2b is outside a predetermined range from the neutral position. The solid line B of FIG. 11 indicates a case where the gain G is constant when the steering angle of each of the steering wheels 2b and 2b is in a predetermined range from the neutral position and the actual stroke Sr increases when the steering angle exceeds a certain position, that is, the gain G increases as the steering angle β increases. The solid line C of FIG. 11 indicates a case where the gain G is constant when the steering angle of each of the steering wheels 2b and 2b is in a predetermined range from the neutral position and the actual stroke Sr increases when the steering angle exceeds a predetermined range, that is, the gain G increases as the steering angle β increases. As indicated by the solid line B and the solid line C, even when the gain G changes, when the steering angle of each of the steering wheels 2b and 2b is in a predetermined range from the neutral position, the gain G becomes smaller than the case where the steering angle of each of the steering wheels 2b and 2b is outside a predetermined range from the neutral position.

The switching unit 27 includes a determination unit 27J, a switch 27SW, and a constant output unit 27B. The determination unit 27J receives the operation state STh of the handle 14 from the handle angle sensor 13. The determination unit 27J outputs the correction instruction value Cnc or the constant Y output from the constant output unit 27B to the solenoid valve 19 based on the operation state STh of the handle 14.

The constant output unit 27B outputs a constant Y as the correction factor Dr in which the control device 20 does not correct the amount of the hydraulic oil supplied from the steering valve unit 50 to the steering cylinder 60, that is, the correction factor Dr which prevents the operation of the solenoid valve 19. In the embodiment, the constant Y is 0 [%]. In this way, when the amount of the hydraulic oil is not corrected, the duty ratio of the solenoid valve 19 becomes 0% and hence the solenoid valve 19 is maintained in a closed state. As a result, since the hydraulic oil ejected from the hydraulic pump 56 is supplied to the steering valve unit 50 without using the solenoid valve 19, the amount of the hydraulic oil supplied from the steering valve unit 50 to the steering cylinder 60 does not change.

The determination unit 27J switches the switch 27SW to an ON state when the handle 14 rotates in the clockwise direction or the counter-clockwise direction. A case where the handle 14 is in the clockwise direction or the counter-clockwise direction is determined by the operation state STh. When the handle 14 is in the clockwise direction or the counter-clockwise direction, the determination unit 27J switches the switch 27SW to the ON state and hence the correction instruction value Cnc is output from the adjustment unit 26 to the solenoid valve 19. The solenoid valve 19 is operated in accordance with the correction instruction value Cnc.

The solenoid valve 19 supplies the hydraulic oil to the steering valve unit 50 so as to realize the target stroke St of the steering cylinder 60 corresponding to the rotation angle θhr of the handle 14. The steering valve unit 50 supplies the hydraulic oil of the amount corresponding to the hydraulic oil supplied from the solenoid valve 19 to the steering cylinder 60. As a result, since the operation amount of the steering cylinder 60 becomes the target stroke St corresponding to the rotation angle θhr of the handle 14, a deviation between the position of the knob 14 of the handle 14 and the position of the steering angle β of each of the steering wheels 2b and 2b is suppressed. When the forklift 1 travels forward, the positional deviation of the knob 16 of the handle 14 is also suppressed.

The determination unit 27J switches the switch 27SW to an OFF state when the operation state STh of the handle 14 is not the clockwise direction and the counter-clockwise direction. Then, the constant Y is output from the constant output unit 27B to the solenoid valve 19. In this case, the solenoid valve 19 is maintained in a closed state. That is, the solenoid valve 19 is not operated.

The functions of the first calculation unit 21, the second calculation unit 22, the correction unit 25, the adjustment unit 26, the third calculation unit 23, the pre-processing unit 24, and the switching unit 27 are realized by, for example, software, firmware, or a combination of software and firmware. The software and the firmware are described as a program and are stored in the memory 20M illustrated in FIG. 2. The processor 20P realizes the functions of the first calculation unit 21, the second calculation unit 22, the correction unit 25, the adjustment unit 26, the third calculation unit 23, the pre-processing unit 24, and the switching unit 27 by reading and performing the program stored in the memory 20M. The program is used to perform the procedures of the first calculation unit 21, the second calculation unit 22, the correction unit 25, the adjustment unit 26, the third calculation unit 23, the pre-processing unit 24, and the switching unit 27 and the work vehicle control method according to the embodiment by a computer.

The functions of the first calculation unit 21, the second calculation unit 22, the correction unit 25, the adjustment unit 26, the third calculation unit 23, the pre-processing unit 24, and the switching unit 27 may be realized by a processing circuit as dedicated hardware. In this case, the processing circuit corresponds to a single circuit, a complex circuit, a programmed processor, a parallel programmed processor, an ASIC (Application Specific Integrated Circuit), a FPGA (Field Programmable Gate Array), or a combination of theses.

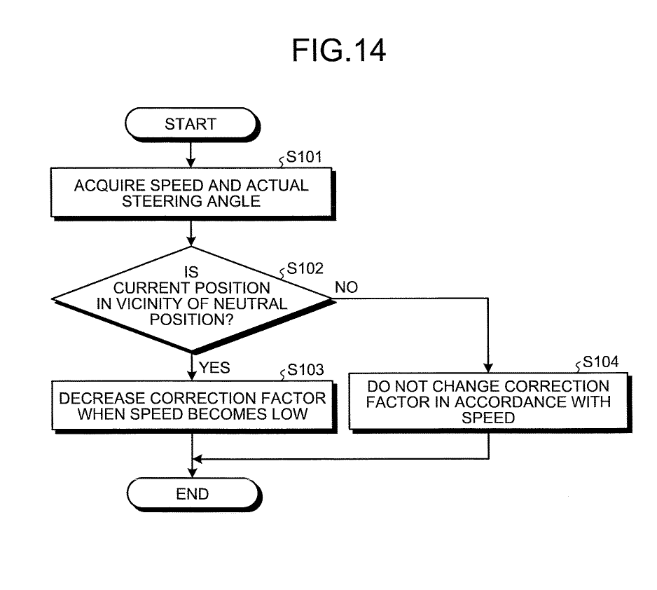

FIG. 14 is a flowchart in which the control device 20 performs the work vehicle control method according to the embodiment. In step S101, the control device 20 acquires the speed V and the actual steering angle βtr. Specifically, the adjustment unit 26 of the control device 20 acquires the speed V and the second calculation unit 22 of the control device 20 acquires the actual steering angle βtr. The second calculation unit 22 obtains the actual stroke Sr from the actual steering angle βtr and gives the result to the adjustment unit 26.

In step S102, when the steering angle of each of the steering wheels 2b and 2b is in the vicinity of the neutral position (step S102, Yes), the control device 20 decreases the correction factor Dr when the speed V increases in step S104. Specifically, the adjustment unit 26 of the control device 20 gives the actual stroke Sr and the speed V to the table TB2 illustrated in FIG. 9 and obtains the corresponding correction factor Dr in step S102 and step S103. Subsequently, when the handle 14 is in the clockwise direction or the counter-clockwise direction as described above, the correction factor Dr obtained by the adjustment unit 26 in step S103 is given to the solenoid valve 19.

In step S102, when the steering angle of each of the steering wheels 2b and 2b does not exist in the vicinity of the neutral position (step S102, No), the control device 20 does not change the correction factor Dr by the speed V in step S104. Specifically, the adjustment unit 26 of the control device 20 gives the actual stroke Sr and the speed V to the table TB2 illustrated in FIG. 9 and obtains the corresponding correction factor Dr in step S102 and step S104. In the table TB2, for example, in the case of the actual stroke Sr2, the steering angle of each of the steering wheels 2b and 2b does not exist in the vicinity of the neutral position, but the gains G12 and G22 corresponding to the actual stroke Sr2 are equal to each other. For this reason, the adjustment unit 26 can obtain the same correction factor Dr regardless of the speed V when the actual stroke Sr in the case where the steering angle of each of the steering wheels 2b and 2b does not exist in the vicinity of the neutral position is given to the table TB2.

Subsequently, when the handle 14 is in the clockwise direction or the counter-clockwise direction as described above, the correction factor Dr obtained by the adjustment unit 26 in step S104 is given to the solenoid valve 19.

As described above, in the embodiment, since the correction factor Dr decreases when the steering angle of each of the steering wheels 2b and 2b is in a predetermined range from the neutral position, the amount of the hydraulic oil supplied to the steering valve unit 50 through the solenoid valve 19 decreases. For that reason, the control device 20 can suppress the steering wheel 2b from being operated excessively more than the amount desired by the operator when the operator operates the handle 14. As a result, in the embodiment, it is possible to suppress hunting from being generated when the steering angle of each of the steering wheels 2b and 2b is in the vicinity of the neutral position in the case where a deviation between the operation amount of the handle 14 and each of the steering angles β of the steering wheels 2b and 2b is corrected in the work vehicle in which the steering wheels 2b and 2b are operated by the handle 14. Further, in the embodiment, the correction factor Dr decreases when the speed V of the forklift 1 increases in the case where the steering angle of each of the steering wheels 2b and 2b is in a predetermined range from the neutral position. As a result, in the embodiment, it is possible to suppress the excessive operations of the steering wheels 2b and 2b when the steering angle of each of the steering wheels 2b and 2b is in the vicinity of the neutral position in the case where the forklift 1 travels at a relative high speed V.

In the embodiment, the solenoid valve 19 is provided in the hydraulic oil supply passage 52, but the solenoid valve 19 may be disposed at any position as long as the amount of the hydraulic oil supplied to the steering cylinder 60 can be adjusted. For example, the first hydraulic oil passage 54 and the second hydraulic oil passage 55 may be connected to each other through a passage and the solenoid valve 19 may be provided in the passage. In the embodiment, one steering cylinder 60 is provided, but the number of the steering cylinders 60 is not limited as long as the steering wheels 2b and 2b can be operated.

The embodiment has been described above, but the embodiment is not limited to the above-described content. Further, the above-described components include a component which can be easily considered by the person skilled in the art and a component which has substantially the same configuration, that is, a component which is in the equivalent range. Further, the above-described components can be appropriately combined with one another. Furthermore, at least one of various omissions, substitutions, and modifications of the components can be made without departing from the spirit of the embodiment.

### REFERENCE SIGNS LIST

1 FORKLIFT
2b STEERING WHEEL
3 VEHICLE BODY
5 WORKING IMPLEMENT
13 HANDLE ANGLE SENSOR
14 HANDLE
15 VEHICLE SPEED SENSOR
16 KNOB
17 STEERING ANGLE SENSOR
19 SOLENOID VALVE
20 CONTROL DEVICE
21 FIRST CALCULATION UNIT
21P MULTIPLYING UNIT
21R CONSTANT GIVING UNIT
22 SECOND CALCULATION UNIT
23 THIRD CALCULATION UNIT
24 PRE-PROCESSING UNIT
25 CORRECTION UNIT
26 ADJUSTMENT UNIT
27 SWITCHING UNIT
30 STEERING SYSTEM
50 STEERING VALVE UNIT
51 WORKING OIL TANK
52 HYDRAULIC OIL SUPPLY PASSAGE
53 HYDRAULIC OIL COLLECTION PASSAGE
54 FIRST HYDRAULIC OIL PASSAGE
55 SECOND HYDRAULIC OIL PASSAGE
56 HYDRAULIC PUMP
60 STEERING CYLINDER
61 STROKE SENSOR
Cnc CORRECTION INSTRUCTION VALUE
Dr CORRECTION FACTOR
G GAIN
Sr ACTUAL STROKE
St TARGET STROKE
STh OPERATION STATE
TB1 TARGET INFORMATION DETERMINATION TABLE
TB2 ACTUAL STEERING ANGLE INFORMATION DETERMINATION TABLE
TB1, TB2 TABLE

1. A work vehicle comprising:
a steering cylinder which operates a steering wheel of a work vehicle by hydraulic oil supplied thereto;
a steering member that receives an input for operating the steering wheel;
a steering valve unit which is connected to the steering member and supplies the hydraulic oil to the steering cylinder;
a first detector which detects an operation amount of the steering member;
a second detector which detects a steering angle of the steering wheel;
a third detector which detects a speed of the work vehicle;
a first calculation unit which obtains target information as information of a target steering angle of the steering wheel with respect to the operation amount of the steering member detected by the first detector;
a second calculation unit which obtains actual steering angle information as information corresponding to an actual steering angle of the steering wheel detected by the second detector;
a correction unit which corrects a deviation amount between the target information and the actual steering angle information; and
an adjustment unit which decreases a correction factor for the deviation amount of the correction unit when a speed of the work vehicle detected by the third detector increases in a case where the second detector detects that the steering angle of the steering wheel is in a predetermined range from a neutral position.

2. The work vehicle according to claim 1, further comprising:
a third calculation unit which obtains a deviation between the target information and the actual steering angle information,
wherein the correction unit changes the correction factor in accordance with the deviation obtained by the third calculation unit.

3. The work vehicle according to claim 1,
wherein the target information indicates a target stroke of the steering cylinder with respect to the operation amount of the steering member detected by the first detector, and the actual steering angle information indicates an actual stroke of the steering cylinder with respect to the actual steering angle.

4. The work vehicle according to claim 1, further comprising:
an adjustment device which adjusts an amount of the hydraulic oil supplied to the steering cylinder,
wherein the correction unit changes the amount of the hydraulic oil supplied to the steering cylinder by controlling the adjustment device.

5. The work vehicle according to claim 1,
wherein the target information with respect to the operation amount of the steering member detected by the first detector is obtained by using an upper limit of a change in the amount of the hydraulic oil supplied from the steering valve unit to the steering cylinder.

6. The work vehicle according to claim 1,
wherein the adjustment unit linearly changes the correction factor.

7. A method of controlling a work vehicle including a steering cylinder which operates a steering wheel of a work vehicle by hydraulic oil supplied thereto, a steering member which receives an input for operating the steering wheel, and a steering valve unit which is connected to the steering member and supplies the hydraulic oil to the steering cylinder, the method of controlling the work vehicle comprising:
obtaining a speed of the work vehicle and a steering angle of the steering wheel; and
decreasing a correction factor for correcting a deviation amount of actual steering angle information of the steering wheel with respect to target information as information on a target steering angle of the steering wheel with respect to an operation amount of the steering member when the speed of the work vehicle increases in a case where the steering angle of the steering wheel obtained based on the steering angle is in a predetermined range from a neutral position.
